(19) United States
(12) Patent Application Publication
(10) Pub. No.: US 2026/0134752 A1
(43) Pub. Date: May 14, 2026

(54) AI BASED RESOURCE CRYPTOCURRENCY MINING IN A CASINO ENVIRONMENT

(71) Applicant: IGT, Las Vegas, NV (US)

(72) Inventors: Aaron COREY, Moncton (CA); Michael RUSS, Graz (AT); Fayez IDRIS, Dieppe (CA); Daniel LANDRY, Moncton (CA)

(73) Assignee: IGT, Las Vegas, NV (US)

(21) Appl. No.: 18/948,153

(22) Filed: Nov. 14, 2024

(51) Int. Cl. G07F 17/32

(52) U.S. Cl. CPC G07F 17/3234; G07F 17/3206; G07F 17/3211; G07F 17/3269; G07F 17/3239

(57) ABSTRACT

Embodiments herein are directed to an electronic gaming machine (EGM), a system and a method. Operations of a method may include determining a blockchain type of mining operations to be performed by multiple EGMs, requesting AI input data from the EGM's that includes prediction data corresponding to operations of the EGMs and that corresponds to the blockchain type. Operations include performing monitoring and scheduling operations corresponding to mining cryptocurrency using the EGMs and based on the blockchain type. Operations include receiving data corresponding to a quantity of users in a casino venue, comparing the quantity of users in the casino venue to a user crowd threshold, in response to the quantity of users being greater that the user crowd threshold, disable blockchain mining operations until the quantity of users is less than the user crowd threshold.

### BACKGROUND

Embodiments described herein relate to operations in a gaming environment (e.g., provided by a casino) that includes electronic gaming machines (“EGMs”). EGMs can provide one or more games (e.g., wagering games) stored therein that can be played by a player. The EGM can provide a prize to the player based on a wager and an outcome of a wagering game. In some examples, a wagering game includes a slot game in which, in response to receiving a wager from the player, one or more rows of symbols are revealed. In additional or alternative examples, a wagering game includes a table game and/or a sports book among others. Additional opportunities for generating revenue using the EGMs may be advantageous.

### SUMMARY

According to some embodiments, a system is provided. The system includes processing circuitry and a memory coupled to the processing circuitry and having instructions stored therein that are executable by the processing circuitry to cause the system to perform operations including determining a blockchain type of mining operations to be performed by multiple EGMs. Operations include requesting AI input data from the EGMs that includes prediction data corresponding to operations of the EGMs and that corresponds to the blockchain type. Operations include performing monitoring and scheduling operations corresponding to mining cryptocurrency using the EGMs and based on the blockchain type.

According to some embodiments, a method is configured to perform operations including determining a blockchain type of mining operations to be performed by multiple EGMs and requesting AI input data from the EGM's that includes prediction data corresponding to operations of the EGMs and that corresponds to the blockchain type. Operations include performing monitoring and scheduling operations corresponding to mining cryptocurrency using the EGMs and based on the blockchain type. In some embodiments, a processing circuitry is further caused to receive data corresponding to a quantity of users in a casino venue, compare the quantity of users in the casino venue to a user crowd threshold and, in response to the quantity of users being greater than the user crowd threshold, disable blockchain mining operations until the quantity of users is less than the user crowd threshold.

According to some embodiments, an electronic gaming machine (EGM) includes a processing circuitry and memory coupled to the processing circuitry and having instructions stored therein that are executable by the processing circuitry to cause the processing circuitry to perform operations including of determining a blockchain type of mining operations to be performed by multiple EGMs and providing, by the EGMs, AI input data that includes historical data corresponding to operations of the EGMs and that correspond to the blockchain type. Operations include performing monitoring and scheduling operations corresponding to mining cryptocurrency using the EGMs and based on a POS blockchain that depends on a quantity of cryptocurrency held by the EGMs to determine mining performance of the plurality of EGMs. Operations further include scheduling ones of the EGMs based on which blocks have been previously used for the POS blockchain mining.

According to other embodiments, EGMs, systems, methods, and non-transitory computer-readable medium are provided for performing the above embodiments.

### BRIEF DESCRIPTION OF THE DRAWINGS

FIG. 1 is a schematic block diagram illustrating an example of a network configuration for a plurality of gaming devices according to some embodiments;

FIGS. 2A-E are diagrams illustrating examples of gaming devices according to some embodiments;

FIG. 3 is a schematic block diagram illustrating various operations for a blockchain token transaction according to some embodiments.

FIG. 4 is a schematic block diagram illustrating components in a system according to some embodiments;

FIG. 5 is a flow chart illustrating an example of operations performed by a system according to some embodiments;

FIG. 6 is a flow chart illustrating an example of operations performed by an electronic gaming machine according to some embodiments; and

FIG. 7 is a flow chart illustrating an example of operations performed by an electronic gaming machine according to some embodiments.

### DETAILED DESCRIPTION

Some embodiments herein are directed to systems and methods of cryptocurrency mining in a networked casino environment, using an artificial intelligence (AI)-based resource management component.

As disclosed herein, multiple casino gaming machines and/or other venue and/or casino-owned computing resources may be interconnected in addition to the AI-based resource management component. Some embodiments provide that the AI component monitors and schedules the cryptocurrency mining processes based on actual, concurrent and/or predicted available computing resources and/or floor occupancy, among others. Further, some embodiments herein describe different approaches within the casino environment based on proof of work and/or proof of stake blockchains, among others.

As described herein, casino venues may typically have their gaming machines and other computing devices running substantially non-stop and may be operated twenty-four hours per day and 7 days per week, regardless of floor occupancy and/or player presence. As such, the EGMs may be running idle for a significant amount of time, every day. While running idle, these EGMs may be used for mining cryptocurrencies and thus may require even more computing power and/or be able to generate a cryptocurrency that comprises monetary value.

In some embodiments, manually triggering the mining process on idle machines may be a non-trivial effort if done by a human. Further, EGMs may be required to have sufficient electrical and computing machines to be available for players to immediately start playing a session on the EGM. In some embodiments, activation and/or deactivation “manually” may be a waste in resources. For example, inefficiencies might be a result from an interrupted mining processes and/or poorly allocated computing resources for a certain mining task.

Embodiments herein may provide a technical solution to address issues raised herein by providing systems that may be based on resource availability and controlled through an AI-based monitoring and scheduling component. The monitoring and scheduling component may be able to efficiently mine cryptocurrencies in an automated process and/or operation automatically.

In some embodiments, a machine manufacturer may offer a system as disclosed herein as a product for increasing opportunities to generate and/or increase revenue creation by meaningfully using EGM machine idle times for cryptocurrency mining.

In some embodiments, crypto currency mining by an operator may be for open-source cryptocurrency such as Bitcoin, Ether, and/or Dogecoin, among others. Some embodiments herein may provide mining blocks of a casino-internal cryptocurrency for internal use with the casino and their players and that may include loyalty coins, and/or casino-internal crypto market, among others.

Some embodiments provide that a joint venture between an operator and a manufacturer may provide that the internal cryptocurrency could be based on a manufacturer-hosted blockchain that may be used for crypto loyalty between the player and the casino. In such embodiments, the manufacturer may host and maintain the blockchain infrastructure and the casino may provide computation power to mine additional coins on the blockchain.

Some embodiments include computing hardware such as gaming machines, servers and/or similar components that can be used for computations. In some embodiments, components for computations may include a graphical processing card, among others.

Some embodiments include proof of work blockchains and/or proof of stake blockchains. Some embodiments provide that an AI-based casino network wide resource may perform monitoring and/or scheduling operations. Some embodiments include a token redistribution controller that identifies which resources are being used and which are not being used. In some embodiments, the token redistribution controller may perform functions of identifying a threshold after a cash out. For example, the controller may determine that after three minutes of idle time, the EGM may convert into an available resource for mining. Some embodiments provide that receiving a cash in signal may result in the EGM status to be non-available for mining.

Some embodiments include retrieving data regarding the number of current casino visitors. The visitor data may be compared to a specified threshold that disables mining completely if the casino is very crowded. For example, the mining operations may be activated or deactivated based on the number of active player tracking cards used and/or based on a casino surveillance camera system.

Some embodiments include automatically retrieving current power supply costs. In such embodiments, if costs become greater than mining outcome, then the mining operations may be deactivated. In some embodiments, the casino may be equipped with intelligent power metering to measure power consumption. In such embodiments, a correlation between the energy information may be correlated with game play activity and/or mining activity. From this data, it can be determined if mining activity is causing excessive power consumption relative to the financial benefits of mining. Some embodiments include AI-based EGM stake monitoring and a token redistribution component.

In some embodiments, mining cryptos may require resources that may be available within gaming machines in the casino venue. Participating casinos and players, depending on the implementation, may be awarded in cash or crypto. In some embodiments, revenues can be split with participating casinos.

Some embodiments provide that gaming machines can be used to mine cryptos when they are not used or experiencing low levels of usage. Examples of such times include idle time and/or no active play, among others. A scheduler may be used to ensure that gaming machines and/or other devices are only used at times where they are not in playing usage and avoid peak times to be cost effective.

For power intensive mining algorithms, the scheduler may take into account machine availability and/or power price at a usage time. For algorithms that don't consume large power amounts, scheduling may be based on idle time and/or consider casino preferences.

In some embodiments, processing components that are already present on available resources can be used if the resource is idle. For example, an idle processing resource may include a gaming machine that has a graphics card that is not being used.

As described herein, different types of blockchains may be used. Example types of blockchains include a proof of work (POW) blockchain and a proof of stake (POS) blockchain, among others.

In the case of a POW blockchain, mining cryptos may require resources that may consume large amounts of power and thus may not be available in some environments. This may be particularly relevant for some types of blockchain consensus mechanisms, such as POW. In the circumstance in which other mechanisms could be used (such as proof of stake), then available computing resources may be less relevant.

To mine blocks in a POW based blockchain, an allocation of maximum available computing power of the casino floor may be used. In this manner, the more machines of the casino that participate the higher not only the chance for a reward but also the reward itself. In some embodiments, an AI monitoring system may automatically monitor which gaming machines are idle. In some embodiments, the outcome of this may automatically trigger the mining process of all available machines.

Some embodiments provide triggers for activating mining on a gaming machine. For example, a POW blockchain could include triggers of a cash out plus some idle time, the credit meter running down to zero followed by idle time, the credit meter being lower than the min bet plus idle time, and/or a low or empty credit meter and no player detected, among others. In some embodiments, such data may be generated using a camera scan and/or presence detection system, among others.

Some embodiments provide that an upcoming mining reward that is greater that power consumption costs may trigger the activation. Such trigger may be determined based on monitoring using an AI system. For example, some embodiments provide that a scheduled time of the day when electricity is less expensive may be used for mining. Some embodiments provide that in some jurisdictions, electricity is sold at a lower price per kilowatt-hour during specific time periods when overall power consumption on the electrical grid is lower.

Some embodiments include triggers for deactivating mining on a gaming machine in a POW blockchain that may include a player pressing any button and/or touch screen of the machine, a player cashing in, player entering their player tracking card, a player authenticating themselves via biometric scan such as face, eye, retina, and/or fingerprint, among others, a player approaching the machine, being detected via a camera scan and/or a presence detection system, among others. Further, deactivating may be triggered if an outcoming mining reward is less than power consumption costs, as determined by monitoring using an AI system.

In some embodiments, a scheduled time of the day when electricity is more expensive may be a basis for deactivating mining. For example, in some jurisdictions electricity is sold at a higher price per kilowatt-hour during specific time periods when overall power consumption on the electrical grid may be higher.

For POW work blockchains, a single gaming device that is about to being used, can be dynamically removed from the mining process without a bigger drawback on the latter. All other gaming devices may continue mining the next block irrespectively.

In some embodiments, POS blockchains may be mined using resource management approaches in a casino environment. Some embodiments provide that a device's ability to validate other blocks/transactions may be based on how many blocks the casino already has. At the same time, new blocks may be created on the validating devices as a reward for contributing to the validation. In such cases, it may be less about finding EGMs with excess computing resources and more about finding EGMs that already have a certain number of blocks.

In some embodiments, new blocks being created in this way may not be immediately awarded to the player unless the player owns the device. For example, if the player is playing an EGM in a casino, the EGM may just accumulate the cryptos until an event occurs in the game to award cryptos to whatever game is being played on the EGM at the time.

In some embodiments, this may be distinct from previously disclosed. Some embodiments may provide that such approaches may be more environmentally friendly and may not depend on multiple EGMs that are mining instead of being played. For example, POS mining may be able to run in the background without affecting the performance of the EGM.

Priorities in POS blockchains differ. Rather than real-time availability of maximum processing power, steady availability and token stake availability might be more important here. Thus, for mining blocks in these chains, the AI monitoring and scheduling component may need to focus more on the scheduling aspect. For example, an EGM that has previously been involved in a particular POS mining task is both to be used for the next block's mining task and purposefully not or not too long to be interrupted in their mining task.

In some embodiments, the AI scheduler may be trained to identify busy time periods and calm time periods of the casino and/or the EGM. A next POS mining task may preferably be initiated on a machine that has mostly been involved into the preceding mining task of this blockchain, and that during a predicted idle time that grants a successful mining of the next block.

Some embodiments provide that multiple different triggers may activate mining on an EGM in a POS blockchain. Such triggers may include a predicted low visitor number in the casino, a predicted idle time of the gaming machine, a casino (or certain area) closing hours, player tracking for tracking multiple players'real-time presence, an analysis of unusual play behavior, and/or a prediction regarding whether or not a certain EGM is going to be played or not.

In some embodiments, a triggering may occur responsive to an outcoming mining reward being greater than the power consumption costs, which may be monitored through, for example, an AI system. Some embodiments provide that triggering may result from predicted power consumption costs, such as, lower power costs during night shifts, among others.

In some embodiments, triggers for deactivating mining on an EGM in a POS blockchain may include a predicted high visitor number in the casino, a predicted high occupancy time of the EGM, and/or the casino opening hours, among others. A deactivating trigger may also be responsive to an outcoming mining reward being less than power consumption costs, which may be monitored using an AI system. Some embodiments include predicted power consumption costs, such as high power costs during daytime operating hours.

Some embodiments provide that, for POS blockchains, it may be undesirable for a gaming device that is involved in the mining or proofing task is about to be used by a player. For example, such occurrences may reduce the size of a pool of EGMs that are involved in the process. For example, the pool of eligible validators may not be large enough for a selection of a well-randomized distribution of validators for a transaction. Thus, this may increase the possibility of fraud such as influencing transactions by hijacking the pool of EGMs. Further, the impact on EGM failures or network disconnections may increase when involved EGMs are removed from the mining/proofing task, which may be avoided in the interest of the operator.

In some embodiments, it may not be necessary to schedule POS mining based on the busy/idle status of the EGMs because this type of mining may not be resource intensive. Thus, it may be possible to mine tokens on an EGM while it's being played.

Some embodiments provide AI-based EGM stake monitoring and a token redistribution component. In some embodiments, an eligibility requirement for proof of stake blockchain mining in the casino may provide that the EGM has an existing stockpile of tokens to be used as the stake in the mining algorithm. In such embodiments, the AI's role may be to monitor each EGM's stake and to redistribute tokens between EGMs. For example, some tokens may be transferred from EGMs that have a large stake to other EGMs that have less or no stake so that all of the EGMs have enough stake to participate in the mining. In some embodiments, the AI may ensure that there is redundancy in the mining so that failures and/or network problems on a few EGMs don't have a negative impact on the overall mining capacity of the casino floor. Further, it may be easier to select a random group of EGMs to be validators for each transaction if there is a large pool of eligible EGMs available. If the number of eligible EGMs is too small, then the same EGMs may often or always get selected to be validators.

A POS mining algorithm may not require significant computing resources. For example, it may not require too much CPU, GPU and/or RAM consumption to cause a noticeable effect on game play. The POS may rely on the stake of tokens held by the participating EGMs. In a POS mining scheme, validators, which may be EGMs that are verifying the blocks and transactions, are selected at random from a larger pool for each transaction. To be eligible to become a validator, an EGM may need to hold a minimum amount based, for example, on a predetermined threshold, of existing tokens as its stake. In some embodiments, the pool of eligible EGMs from which validators are selected may consist of all EGMs on the casino floor that are holding a sufficient number of tokens.

One of the selected validators may be randomly selected to be the proposer. The proposer may be responsible for creating the new block, which represents the transaction being attempted on the blockchain and sends it to other nodes on the network. The other validators vote on the validity of the new block.

For POS to function efficiently and be resistant to tampering or fraud, the pool of eligible EGMs may be large enough so that the random selection of validators for each transaction will contain at least some different EGMs compared to previous transactions. AI may be used to monitor the stake held by each EGM on the casino floor and then balance out the stake between the entire population of EGMs so that the tokens don't become concentrated in a small number of EGMs. Balance may be achieved by executing blockchain transactions to transfer tokens from EGMs with large stakes to EGMs with small stakes or no stakes.

The balancing operation has several benefits. For example, balancing may provide that the pool of eligible validators is large enough to select a well-randomized set of validators for each transaction. In this manner, having the same EGMs being selected as validators every time may be avoided. This may help minimize the possibility of fraud by influencing transactions by hijacking the pool with compromised EGMs that hold very large stakes. Embodiments herein may minimize the impact of EGM failures and/or network disconnections. As such, there may still be enough EGMs remaining in the pool with a big enough stake to be eligible as validators.

According to embodiments herein, AI component processing may rely on specific input data to perform the AI processing and/or training. Some embodiments provide that input data includes which blockchain that is to be mined including information regarding POS and/or POW, among others. Other inputs may include real-time casino floor occupancy, real-time gaming machine occupancy, and/or real-time visitor presence, among others. In some embodiments, the input data may be personalized through authentication. Other data may include actual power costs, time of day, day of week, bank holidays, casino opening hours, and/or a portion of casino area opening hours, among others.

Some embodiments provide that inputs may include information about which gaming device is involved in which mining task, information about previously performed mining tasks of an EGM, information about the number of tokens held by each EGM, information about computation power of each gaming device, forced inputs through the operator, such as overruling an AI decision, and/or player input regarding whether or not they want their EGM to perform mining operations. Additionally, some embodiments information may include a success rate of the AI's previous prediction including whether or not the prediction was correct or incorrect and was profit generated through mining.

Training and AI model usage may include which models (e.g., decision tree, neural network, random forest, time series models, etc.) are used, how the output changes due to the inventive concepts of the algorithm and how the results are evaluated and/or generalized. In some embodiments, the AI may provide a predicted casino floor occupancy, a predicted gaming machine occupancy, a predicted likelihood of a particular EGM being used soon and/or selection of a certain blockchain depending on its current mining cost effectiveness.

In some embodiments, the AI may provide outputs that may include explicit new information and/or improvements to provide to customers, players, and/or both or neither. For example, for each EGM, a trigger may be generated that predicts if mining should be initiated or stopped based on an input. Some embodiments pay predict an answer to the query as to whether mining is cost effective currently or not. In some embodiments, redistribution of tokens from one or multiple EGMs based on their stake to one or multiple other EGMs may be based on their stake requirements.

Some embodiments provide scheduling the use of EGMs and other types of devices to improve and/or ensure. For example, casinos may generate revenues of their idle EGMs. In some embodiments, scheduling may be manual, automated, or mixed to ensure resources are used during idle time, during optimum power grid time (lower cost and/or lower load) and/or scheduled manually to run within a specific time window, other restrictions and optimizations may be included for optimization.

In some embodiments, device-integrated resource monitoring may be aware of hardware specs and/or resource consumption corresponding to specific game events. In some embodiments, the monitoring unit may be integrated into the specific EGM. Some embodiments provide that it may know about the specs of the EGM and its computing power to mine cryptos.

In some embodiments, the EGM may know about the computing power needed for specific game events within the active game. For example, specific game events may include power for a base game, a bonus game 1, a bonus game 2, an idle mode, and/or an attract mode, among others.

Some embodiments provide that continuously, the monitoring unit compares the hardware specs with the software requirements and evaluates the delta depending on the current game events. In some embodiments, as soon as the delta is big enough to mine cryptos in parallel, the monitoring unit may initiate the respective signal to initiate the process. Whenever a game event is active that does not allow mining in parallel, the monitoring unit may be paused.

In some embodiments, the player may be provided with a choice of game performance versus background mining. For example, a player may choose that they would accept a lower (frames per second) FPS rate while playing if the cryptos are being mined. For example, a decrease from 60 FPS to 30 FPS, and experience the creation of cryptos in parallel. In some embodiments, a player could adjust which game events they would like to experience in a more performance presentation and which game events that may be less important to them so that the performance could be decreased for parallel mining.

Some embodiments include introducing an on-screen mining cash meter that displays to the user how much money they have gained from mining. For example, a cash meter may display mining data on the current day, in the current casino visit, and/or in the current game session, among others. This may encourage the player to allow more resources of their currently played gaming machine while activating as many of their personal devices for mining.

Some embodiments provide that distribute EGM-owned tokens may be distributed between EGMs to ensure all EGMs have a sufficient number of tokens to be eligible as validators in a POS mining blockchain. In some embodiments, a server may keep track of the number of tokens owned by each EGM. Som embodiments provide that these would be EGM-owned tokens not yet awarded to any player.

In some embodiments, a server may balance the number of tokens held by each EGM so that the tokens are as evenly distributed as possible across all of the EGMs in the casino. The balancing may be achieved by transferring EGM-owned tokens between EGMs. For example, the ownership of the tokens may be transferred from an EGM having more tokens to an EGM having fewer tokens.

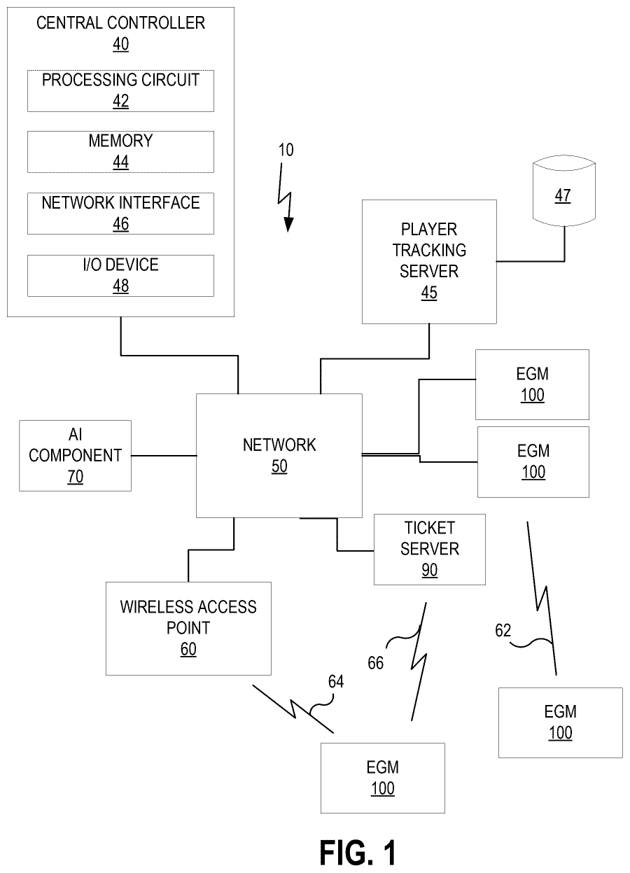

Before describing these and other embodiments in detail, reference is made to FIG. 1, which illustrates a gaming system 10 including a plurality of gaming devices 100. As discussed above, the gaming devices 100 may be one type of a variety of different types of gaming devices, such as electronic gaming machines (EGMs), mobile devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The central controller 40 can include processing circuit 42, memory 44, network interface 46, and an input/output (“I/O”) device 48. In some examples, the memory 44 includes instructions executable by processing circuit 42 for causing the central controller 40 to perform operations. The operations can include communicating with the data communication network 50 via the network interface 46 and/or communicating with a user/operator via the I/O device 48.

The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

An Artificial Intelligent AI component 70 may monitor and/or schedule the cryptocurrency mining processes based on actual, concurrent and/or predicted available computing resources and/or floor occupancy, among others. The AI component 70 may be in communication with the central controller 40 through the data communication network 50. Each AI component 70, and/or portion thereof, may include a processor circuit that transmits and receives events, messages, commands or any other suitable data or signal between the AI component 70 and the central controller 40.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

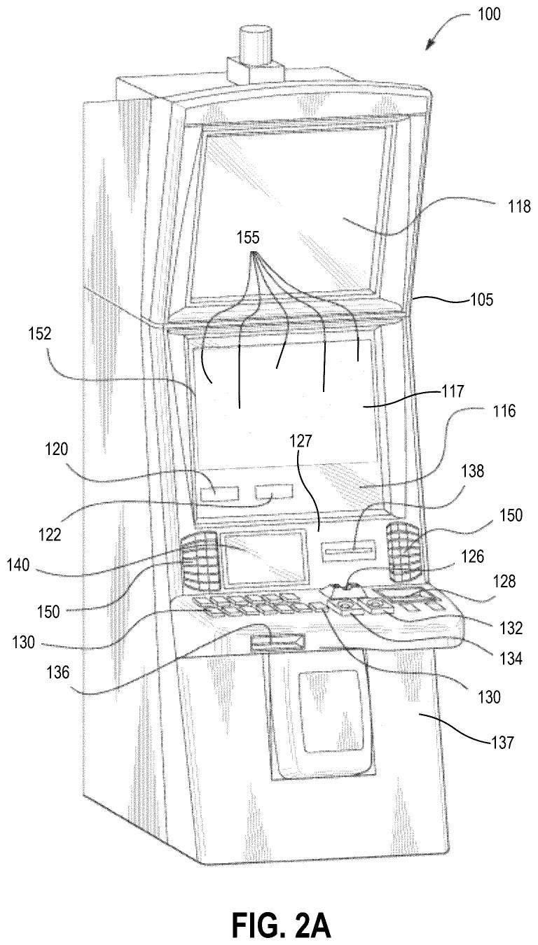

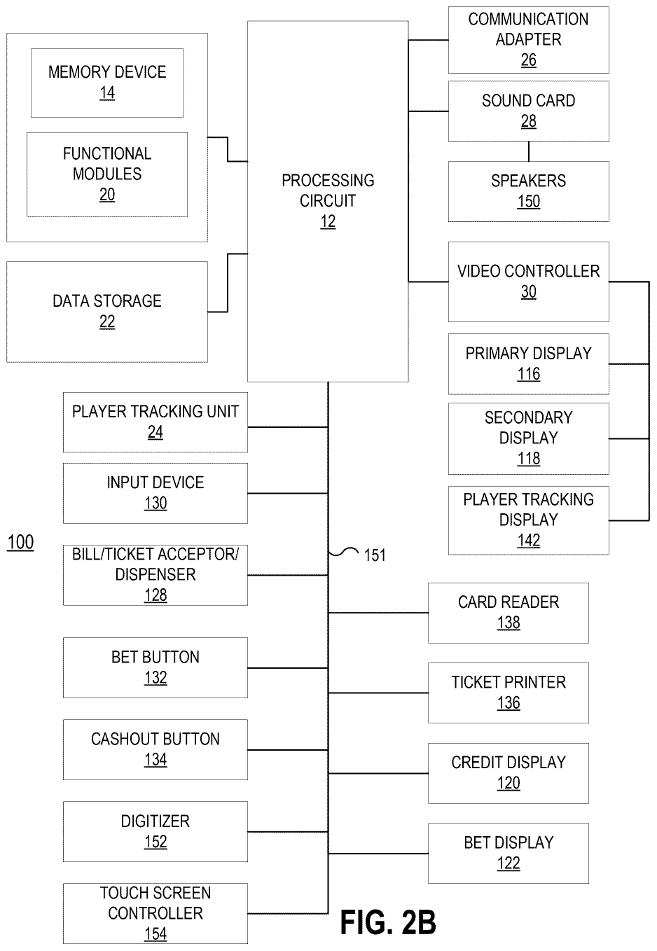

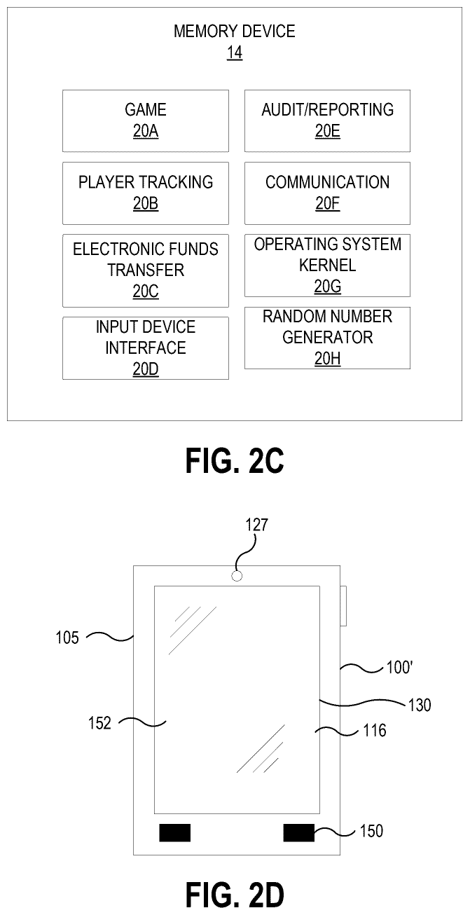

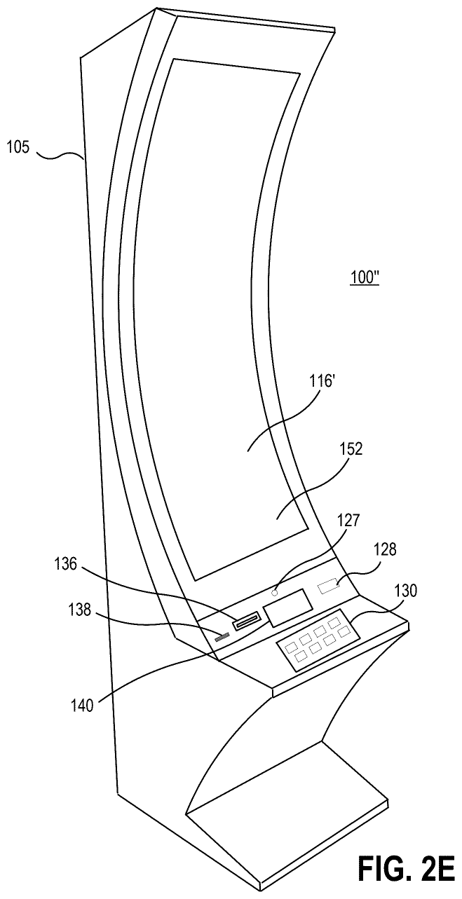

Embodiments herein may include different types of gaming devices. Various embodiments are illustrated in FIGS. 2A-2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A-C are provided as examples for illustrative purposes only. It will be appreciated that gaming devices may come in many different shapes, sizes, layouts, form factors, and configurations, and with varying numbers and types of input and output devices, and that embodiments of the inventive concepts are not limited to the particular gaming device structures described herein.

Gaming devices 100 typically include a number of standard features, many of which are illustrated in FIGS. 2A-B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30. The gaming device 100 may also include a player tracking unit 24 for managing communications and functionality between the processor circuit 12 and certain peripherals and components. Player tracking units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the game play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

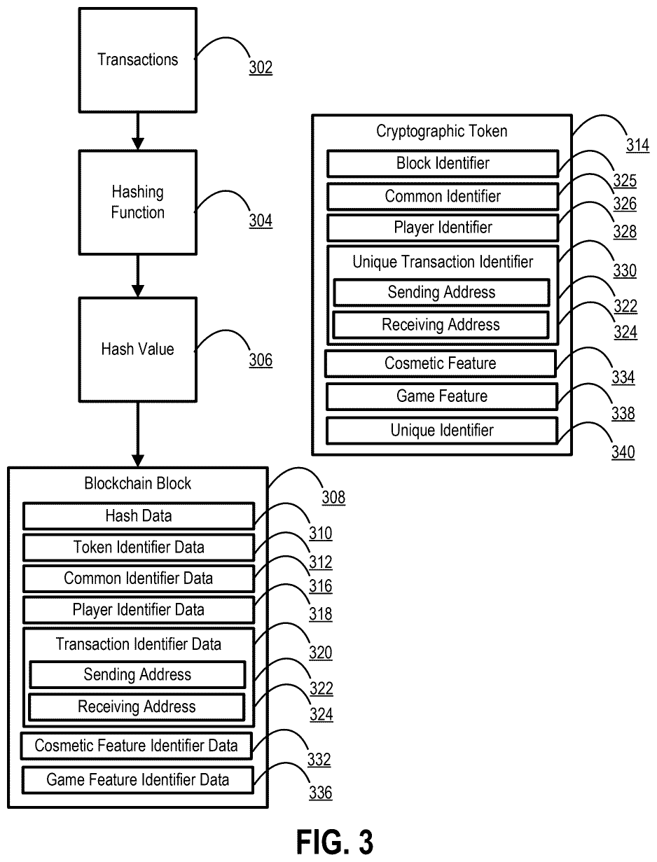

For example, referring to FIG. 2D, a gaming device 100′ may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits can be deposited in or transferred from the gaming device 100′ electronically.

FIG. 2E illustrates a standalone gaming device 100″, i.e., an EGM in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a player tracking display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGMs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Referring now to FIG. 3, a schematic block diagram illustrates various operations for a blockchain transaction recordation according to some embodiments. As illustrated in FIG. 3, transactions 302 may occur at various blockchain nodes. In accordance with various embodiments, a hash may be created for each entry. For example, a cryptographic hash function may create a one-way, (essentially) collision free signature of the entry. The hash algorithm generates a hash. Using hashing function 304, hash values 306 of these transactions are created and added to blockchain blocks 308 that are in the blockchain data structure.

In this example, each blockchain block 308 may include one or more different types of data. For example, each blockchain block 308 may include cryptographic hash data 310 indicative of a result of the hashing function 304 associated with a common blockchain, token identifier data 312 indicative of an identity of a cryptographic token 314 associated with the block 308, common identifier data 316 indicative of the cryptographic token 314 being part of a plurality of cryptographic tokens, e.g., a defined subset of tokens based on different criteria, associated with the common blockchain, player identifier data 318 indicative of an identity of a player associated with the cryptographic token 314, transaction identifier data 320 associated with the unique transaction on the blockchain, which may include a sending address 322 associated with a provider of the cryptographic token 314 and a receiving address 324 associated with the player identifier data 318.

The cryptographic token 314 may include some or all of the data structure of the respective associated block 308 and/or may contain a block identifier 325 referring to the associated block 308, which allows the cryptographic token 314 to be securely and transparently authenticated against the blockchain. In some examples, the cryptographic token 314 may include a common identifier 326 corresponding to the common identifier data 316 and indicative of the cryptographic token 314 being part of the plurality of cryptographic tokens, and a player identifier 328 corresponding to the player identifier data 318 and indicative of a player associated with the cryptographic token 314. The cryptographic token 314 may include a unique transaction identifier 330 associated with a unique transaction on the blockchain, i.e., a unique block 308, and may include the sending address 322 and/or the receiving address 324.

For example, a new transaction for the cryptographic token may include transmitting a transaction indication of the new transaction including a sending address 322 and receiving address 324, and, based on the transaction indication, modifying the player identifier data 318 in a new block 308 and/or the player identifier 328 of the cryptographic token 314 to be indicative of a different player.

In some examples, each block 308 may further include cosmetic feature identifier data 332 associated with a cosmetic feature 334, such as a stored graphical image and/or a graphical modification of a game element of a wagering game. Each block 308 may further include game feature identifier data 336 associated with a game feature 338 for redeeming a portion of a non-monetary credit amount as a monetary award amount. Each cryptographic token 314 may be a fungible token that is fungible with other cryptographic tokens, and/or may further include a unique identifier 340, which may correspond to the token identifier data 312 of the block 308, such that the cryptographic token 314 is a non-fungible token that is not fungible with other cryptographic tokens.

As a general principle, a validation process may be performed to ensure that each new blockchain block 308 meets the criteria for inclusion into the blockchain data structure. In a blockchain configuration, there are varying consensus algorithms that can be used. For example, a private blockchain may choose an algorithm such as Practical Byzantine Fault Tolerance (PBFT). The PBFT mechanism may be useful for small networks, such as networks having fewer than about 100 nodes. Other examples include a Proof of Work (PoW) consensus algorithm and/or a Proof of Stake (PoS) consensus algorithm, which may be used as the value of an underlying data block and/or value changes.

Various embodiments herein describe event-specific cryptographic tokens that interact with other activities that are independent from the event (e.g., activities at a casino where the event is being held). In some embodiments, a player obtains an event-specific cryptographic token in order to be granted an initial level of access to an event. The level of access can be improved and/or expanded based on the other activities (e.g., casino gameplay). In additional or alternative embodiments, by providing an indication that the player has access to the event (e.g., by providing an indication of the cryptographic token), game features associated with casino gameplay can be modified. In some examples, a player of an EGM may own a cryptographic token that provides access to a formula one race. In response to providing an indication of the cryptographic token to the EGM, the EGM may alter a graphical element of a wagering game provided by the EGM to be associated with the formula one race.

In some embodiments, a gaming system (e.g., system 10 of FIG. 1) may support NFTs and blockchain-based gameplay. In some examples, a player may keep cryptographic tokens in a virtual wallet accessible by the system. The event-specific cryptographic tokens can be verified on a blockchain, that grant specific rights/functionality at specific events. Such events could be events taking place in a casino (e.g., an actor or a singer) or it could be casino-specific (gaming-related) events.

In additional or alternative embodiments, event-specific cryptographic tokens can be of different tiering. In some examples, a high tier “VIP token” can grant more rights than a low tier “Regular token.” This can be relevant in the event itself and before or after the event. In additional or alternative embodiments, event-specific cryptographic tokens can be purchased, traded, or won (completely random or based on status/game play).

In additional or alternative embodiments, event-specific cryptographic tokens can be enhanced prior to the event, for example, by gameplay in the casino while having the event cryptographic token enabled. By doing so, a “low tier event token” might be upgraded to a “high tier event token” based on game play. The cryptographic token can be stored in the player's crypto wallet. In some examples, casino games request an indication of a cryptographic token to be activated (e.g., to associate game play with).

In some examples, an event-specific cryptographic token is gained by the player (e.g., purchased, won, or traded. The event-specific cryptographic token may start as a “Regular token” for the specific event. Ownership of that event-specific cryptographic token grants the owner “regular” benefits (e.g., eligibility to the event, regular seat). When activating that event-specific cryptographic token during gameplay, by playing, the event-specific cryptographic token is making progress. Once a gameplay threshold is reached, the “Regular token” turns into a “VIP token” that grants the player VIP benefits (e.g., no entrance fee to the event, plus VIP seats).

In additional or alternative embodiments, a system (either decentralized or operated by the casino) tracks game play with the “activated” token. Once a threshold is reached (e.g., a number of spins played), the event-specific cryptographic token will automatically upgrade in the player's wallet.

In some embodiments, a progress indicator can be provided indicating a cryptographic token's progress towards being modified. In some examples, an EGM can provide a visual indicator (e.g., a progress bar that fills during gameplay). Once the bar is full, the event-specific cryptographic token can be upgraded to a next level. In additional or alternative examples, upgrading the event-specific cryptographic token may include requiring a user decision (e.g., a selection of one improvement of a number of potential improvements). The user decision may include a selection as part of an evolution tree (e.g., point earned from gameplay may be used to evolve the cryptographic token based on a path through a tree structure of different improvements.

In additional or alternative embodiments, a non-event cryptographic token can become an event-specific cryptographic token based on gameplay. In some examples, a player can earn a traditional token (e.g., a cosmetic NFT without any function). Next, the game or the player's crypto wallet can indicate that this traditional token has the ability to become an event-specific cryptographic token by upgrading it based on gameplay. In additional or alternative examples, a player can define, once a traditional token is ready to become an event-specific cryptographic token, which specific event it should provide access to. Upon doing so, the player would gain the benefits for the chosen event. In additional or alternative embodiments, an event-specific cryptographic token can become a multi-event cryptographic token that grants access to multiple different events. In some examples, multiple event-specific cryptographic tokens can be merged into a multi-event cryptographic token.

Based on gameplay, an event-specific cryptographic token can be upgraded according to personal preferences, granting player-defined benefits for and/or after the event. In some embodiments, the event-specific cryptographic token can modify game features of a wagering game based on the level of access and/or the type of event associated with the event-specific cryptographic token. In some examples, if it is a Wheel-of-Fortune related event, then all Wheel-of-Fortune games may support the token modification feature ability and may adjust a pay table associated with the game in response to being provided an indication of a cryptographic token. In additional or alternative examples, if there is a Madonna event upcoming, then several (or all) games in the venue would temporarily get Madonna-assets integrated into the game.

In some embodiments, the gameplay is associated with a slot game, a table game, or a sports wager. In additional or alternative embodiments, progress towards a threshold amount of gameplay is linear and step-wise. In additional or alternative embodiments, progress towards the threshold amount of gameplay can depend on environmental factors (e.g., spatial or temporal proximity to the event), or a type of game play (e.g., free spins may gain a different number of points than wagered spins of a slot machine). In additional or alternative embodiments, the threshold amount of gameplay may require gameplay by other players. In some examples, the threshold amount of gameplay includes a gameplay goal being simultaneously met on three linked EGMs. In additional or alternative embodiments, the threshold amount of gameplay may require reoccurring gameplay. In some examples, upgrades to a cryptographic token are not permanent, for example, they may require maintaining or repeating an amount of gameplay.

Event-specific cryptographic tokens can also be traded and can have a predetermined resell license fee included for every transaction from the owner to the buyer. For example, 2% of the resell price would go to the operator and another 2% would go to the actor themselves. Thus, both operator and actor would benefit from an event-specific cryptographic token being traded.

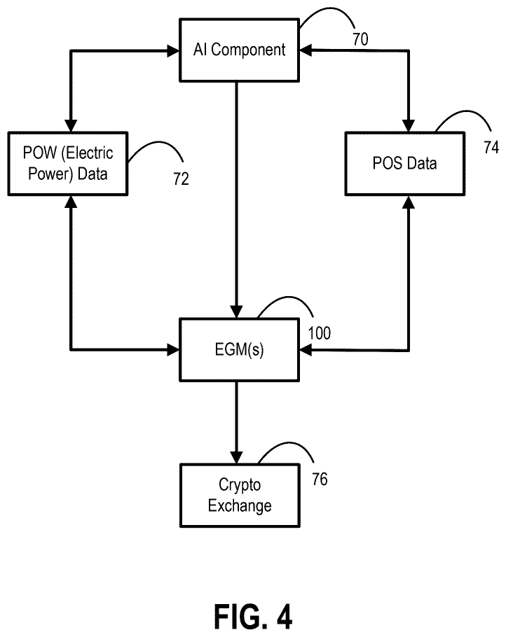

Brief reference is now made to FIG. 4, which is a schematic block diagram illustrating components in a system according to some embodiments. As provided here, an AI component 70 may provide monitoring and/or scheduling of EGM 100 operations in conjunction with a crypto exchange 76 that is configured to provide a repository and/or exchange for cryptographic tokens that may be managed by and/or generated by EGMs 100. For example, in the context of a POW blockchain, the AI component 70 may monitor, accumulate and/or generate data corresponding to electrical power usage and/or availability of POW data 72. In the context of a POS blockchain, the AI component 70 may monitor, accumulate, and/or generate data corresponding to a quantity of tokens and/or blocks held by the EGM's 100 both in aggregate and for each EGM 100.

In some embodiments, the AI component 70 may collect and/or generate data that may be used to train the AI component 70. In this manner, the AI component 70 may provide iterative improvements in future performance and/or predictions based on the training.

Although referred to herein, embodiments recite EGMs 100. However, embodiments herein are not so limited. For example, embodiments herein may include servers, electronic table games ETGs, video lottery terminals VLTs, sports book terminals and/or machines, among others.

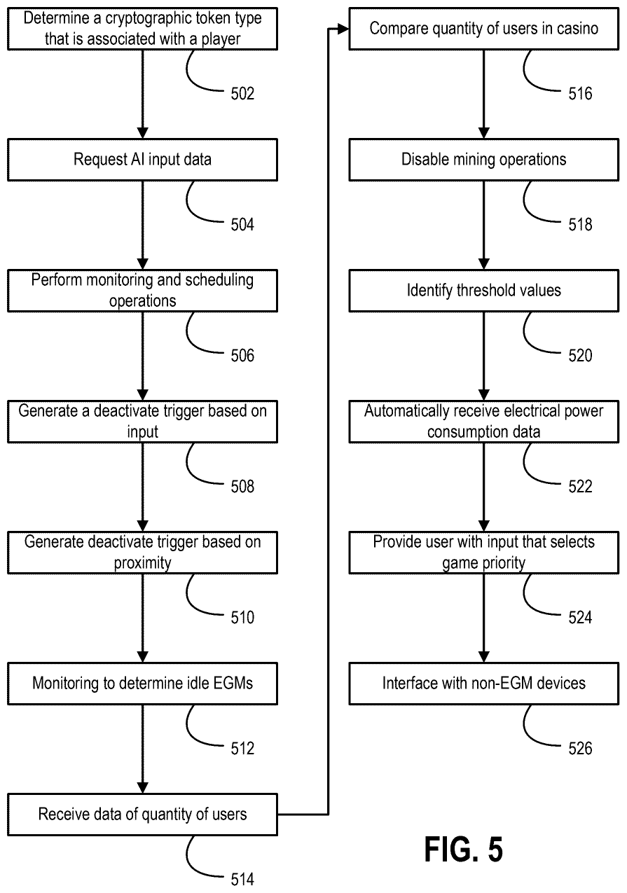

Reference is now made to FIG. 5, which illustrates examples of operations performed by a system according to some embodiments. Although the operations may be described in the context of processing circuit 42 of a central controller 40, the operations can be performed by any suitable system and/or any device within a system. Such systems may include processing circuitry and memory coupled to the processing circuitry and having instructions stored therein that are executable by the processing circuitry to cause the system to perform operations disclosed herein. For example, operations may include determining (block 502) a blockchain type of mining operations to be performed by the EGMs. In some embodiments, the blockchain type includes a proof of work (POW) blockchain that depends on electrical energy surplus power to determine mining performance.

In some embodiments, the blockchain type includes a proof of stake (POS) blockchain that depends on a quantity of cryptocurrency held by the EGMs to determine mining performance of the EGMs. In some embodiments, mining for POS blockchain using the EGMs includes scheduling ones of the EGMs based on which blocks have been previously used for a mining. Some embodiments provide that an eligibility requirement for POS mining includes using a stockpile of existing blockchain tokens to be used as a stake in a blockchain mining algorithm by transferring some of a first EGM to a second EGM to provide redundancy of tokens for stake in mining. In some embodiments, ones of the of EGMs are randomly selected to be a plurality of validating EGMs and are determined to hold a minimum quantity of POS blockchain tokens.

Operations include requesting (block 504) AI input data from the EGMs that includes prediction data corresponding to operations of the EGMs and that corresponds to the blockchain type.

Operations include performing (block 506) monitoring and scheduling operations corresponding to mining cryptocurrency using the EGMs and based on the blockchain type.

In some embodiments, the processing circuitry is caused to generate (block 508) a deactivate trigger that causes mining activities on one of the EGMs to deactivate responsive to any input received from a player of the one of the EGMs. In some embodiments, the processing circuitry is caused to generate (block 510) a deactivate trigger that causes mining activities on an EGM to deactivate responsive to detecting proximity of a player to the EGM. Some embodiments provide that the proximity is determined using an occupancy sensor. In some embodiments, the processing circuitry is caused to perform monitoring (block 512) to determine which of the EGMs are idle and to automatically trigger an activation signal to activate all idle ones of the EGMs.

In some embodiments, the processing circuitry is further caused to receive (block 514) data corresponding to a quantity of users in a casino venue and to compare (block 516) the quantity of users in the casino venue to a user crowd threshold. In response to the quantity of users being greater than the user crowd threshold, the processing circuitry is caused to disable (block 518) blockchain mining operations until the quantity of users is less than the user crowd threshold.

In some embodiments, the processing circuitry is further caused to identify (block 520) threshold values corresponding to a plurality of resource levels of a given EGM of the plurality of EGMs.

In some embodiments, a cryptocurrency includes an internal cryptocurrency that is limited to transactions on a private cryptocurrency exchange and corresponding to a casino brand.

Some embodiments provide that performing and scheduling operations include changing an active EGM to an inactive EGM responsive to a cost of cryptographic mining that is more expensive than a cryptographic mining outcome.

Some embodiments provide that the processing circuitry is caused to automatically receive (block 522) electrical power consumption data corresponding to game play activity and mining activity and to determine an activity state of a mining operation based on the electrical power consumption data.

Some embodiments provide that performing monitoring and scheduling operations include determining computing power used in specific game events within an active game. Operations further include comparing hardware operational data with software requirements and determining to initiate a POS blockchain based on the hardware operational data and the software requirements being capable of running blockchain mining in parallel.

In some embodiments, the processing circuitry is further caused to provide (block 524) a user with an input that selects a game priority of background blockchain mining over game performance of a currently played game.

Some embodiments include a display device, wherein the processing circuitry is further caused to display an on-screen mining cash meter that displays an amount of value that a player has gained through mining. In some embodiments, the display device is configured to display an arrangement of icons on the screen that are relevant to the mining cash meter and that include a relative position of the icons on the display device based on the mining cash meter.

In some embodiments, the processing circuitry is further caused to interface (block 526) with non-EGM devices to provide computing resources that are external to any of the EGMs.

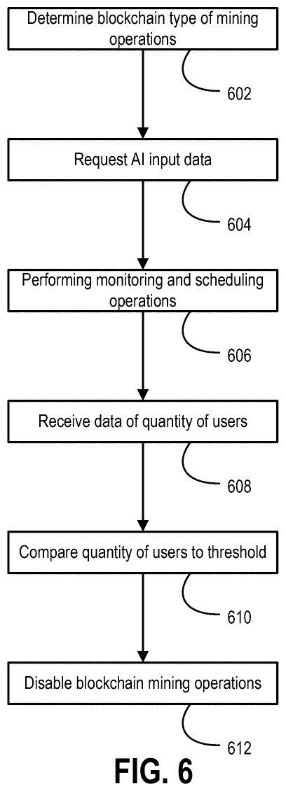

Reference is now made to FIG. 6, which is a flow chart illustrating an example of operations according to some embodiments. Operations include determining (block 602) a blockchain type of mining operations to be performed by multiple EGMs. Operations further include requesting (block 604) AI input data from the EGM's that includes prediction data corresponding to operations of the EGMs and that corresponds to the blockchain type. Operations include performing (block 606) monitoring and scheduling operations corresponding to mining cryptocurrency using the EGMs and based on the blockchain type. Operations include receiving (block 608) data corresponding to a quantity of users in a casino venue and comparing (block 610) the quantity of users in the casino venue to a user crowd threshold. Operations include, in response to the quantity of users being greater than the user crowd threshold, disabling (block 612) blockchain mining operations until the quantity of users is less than the user crowd threshold.

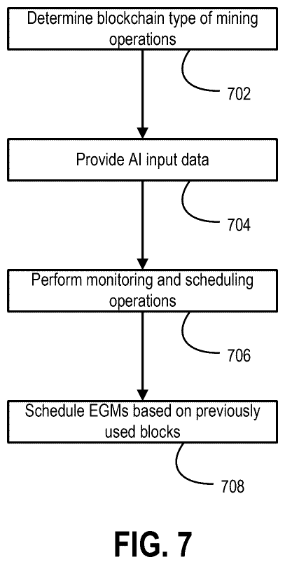

Reference is now made to FIG. 7, which is a flow chart illustrating an example of operations according to some embodiments. Operations include determining (block 702) a blockchain type of mining operations to be performed by multiple EGMs and providing (block 704), by the EGMs, AI input data that includes historical data corresponding to operations of the EGMs and that correspond to the blockchain type. Operations include performing (block 706) monitoring and scheduling operations corresponding to mining cryptocurrency using the EGMs and based on a POS blockchain that depends on a quantity of cryptocurrency held by the EGMs to determine mining performance of the EGMs and scheduling (block 708) ones of the EGMs based on which blocks have been previously used for the POS blockchain mining.

Various operations from the flow charts of FIGS. 5, 6 and/or 7 may be optional with respect to some embodiments systems and related methods.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the FIGS. illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
processing circuitry; and
memory coupled to the processing circuitry and having instructions stored therein that are executable by the processing circuitry to cause the system to perform operations comprising:
determining a blockchain type of mining operations to be performed by a plurality of EGMs;
requesting AI input data from the plurality of EGMs that comprises prediction data corresponding to operations of the plurality of EGMs and that corresponds to the blockchain type; and
performing monitoring and scheduling operations corresponding to mining cryptocurrency using the plurality of EGMs and based on the blockchain type.

2. The system of claim 1, wherein the blockchain type comprises a proof of work (POW) blockchain that depends on electrical energy surplus power to determine mining performance.

3. The system of claim 2, wherein the processing circuitry is caused to generate a deactivate trigger that causes mining activities on one of the plurality of EGMs to deactivate responsive to any input received from a player of the one of the plurality of EGMs.

4. The system of claim 2, wherein the processing circuitry is caused to generate a deactivate trigger that causes mining activities on an EGM to deactivate responsive to detecting proximity of a player to the EGM via an occupancy sensor.

5. The system of claim 2, wherein the processing circuitry is caused to perform monitoring to determine which of the plurality of EGMs are idle and to automatically trigger an activation signal to activate all idle ones of the plurality of EGMs.

6. The system of claim 1, wherein the blockchain type comprises a proof of stake (POS) blockchain that depends on a quantity of cryptocurrency held by the plurality of EGMs to determine mining performance of the plurality of EGMs.

7. The system of claim 6, wherein mining for POS blockchain using the plurality of EGMs comprises scheduling ones of the plurality of EGMs based on which blocks have been previously used for a mining.

8. The system of claim 6, wherein an eligibility requirement for POS mining comprises using a stockpile of existing blockchain tokens to be used as a stake in a blockchain mining algorithm by transferring some of a first EGM to a second EGM to provide redundancy of tokens for stake in mining.

9. The system of claim 6, wherein ones of the plurality of EGMs are randomly selected to be a plurality of validating EGMs and are determined to hold a minimum quantity of POS blockchain tokens.

10. The system of claim 1, wherein the processing circuitry is further caused to:
receive data corresponding to a quantity of users in a casino venue;
compare the quantity of users in the casino venue to a user crowd threshold; and,
in response to the quantity of users being greater than the user crowd threshold, disable blockchain mining operations until the quantity of users is less than the user crowd threshold.

11. The system of claim 1, wherein the processing circuitry is further caused to identify threshold values corresponding to a plurality of resource levels of a given EGM of the plurality of EGMs.

12. The system of claim 1, wherein a cryptocurrency comprises an internal cryptocurrency that is limited to transactions on a private cryptocurrency exchange corresponding to a casino brand.

13. The system of claim 1, wherein performing and scheduling operations comprise changing an active EGM to an inactive EGM responsive to a cost of cryptographic mining that is more expensive than a cryptographic mining outcome.

14. The system of claim 1, wherein the processing circuitry is caused to automatically receive electrical power consumption data corresponding to game play activity and mining activity and to determine an activity state of a mining operation based on the electrical power consumption data.

15. The system of claim 1, wherein performing monitoring and scheduling operations comprises:
determining computing power used in specific game events within an active game; and
comparing hardware operational data with software requirements, and determining to initiate POS blockchain based on the hardware operational data and the software requirements being capable of running blockchain mining in parallel.

16. The system of claim 1, wherein the processing circuitry is further caused to provide a user with an input that selects a game priority of background blockchain mining over game performance of a currently played game.

17. The system of claim 1, further comprising a display device, wherein the processing circuitry is further caused to display an on-screen mining cash meter that displays an amount of value that a player has gained through mining.

18. The system of claim 17, wherein the processing circuitry is further caused to interface with non-EGM devices to provide computing resources that are external to any of the plurality of EGMs.

19. A method comprising:
determining a blockchain type of mining operations to be performed by a plurality of EGMs;
requesting AI input data from the plurality of EGM's that comprises prediction data corresponding to operations of the plurality of EGMs and that corresponds to the blockchain type; and
performing monitoring and scheduling operations corresponding to mining cryptocurrency using the plurality of EGMs and based on the blockchain type; and
wherein a processing circuitry is further caused to:
receive data corresponding to a quantity of users in a casino venue;
compare the quantity of users in the casino venue to a user crowd threshold; and,
in response to the quantity of users being greater than the user crowd threshold, disable blockchain mining operations until the quantity of users is less than the user crowd threshold.

20. An electronic gaming machine (“EGM”) comprising:
a processing circuitry; and
memory coupled to the processing circuitry and having instructions stored therein that are executable by the processing circuitry to cause the processing circuitry to perform operations comprising of:
determining a blockchain type of mining operations to be performed by a plurality of the EGMs;
providing, by the plurality of EGMs, AI input data that comprises historical data corresponding to operations of the plurality of EGMs and that correspond to the blockchain type;
performing monitoring and scheduling operations corresponding to mining cryptocurrency using the plurality of EGMs and based on a POS blockchain that depends on a quantity of cryptocurrency held by the plurality of EGMs to determine mining performance of the plurality of EGMs; and
scheduling ones of the plurality of EGMs based on which blocks have been previously used for the POS blockchain mining.
